(19) United States
(12) Patent Application Publication
(10) Pub. No.: US 2025/0220269 A1
(43) Pub. Date: Jul. 3, 2025

(54) DETERMINING PLAY SPEEDS FOR RENDERING VIDEO CONTENT IN A VIDEO PLAYER

(71) Applicant: INTERNATIONAL BUSINESS MACHINES CORPORATION, ARMONK, NY (US)

(72) Inventors: Jun Su, Beijing (CN); YANG LIANG, Beijing (CN); Su Liu, Austin, TX (US); Shunguo Yan, Austin, TX (US)

(21) Appl. No.: 18/402,466

(22) Filed: Jan. 2, 2024

(51) Int. Cl. H04N 21/462; H04N 21/44; H04N 21/442; H04N 21/466

(52) U.S. Cl. CPC H04N 21/462; H04N 21/44008; H04N 21/44218; H04N 21/4667

(57) ABSTRACT

Provided are a computer program product, system, and method for determining play speeds for rendering video content in a video player. A determination is made of segment complexity scores of segments of a video are determined. A determination is made of user comprehension score for a viewer of the video with respect to a category of the video. A preferred speed predictor machine learning model receives input comprising the segment complexity scores and the user comprehension scores for the categories of the video to output predicted play speeds for the segments of the video. The segments of the video in the video player are rendered according to the predicted play speeds of the segments.

### BACKGROUND OF THE INVENTION

### 1. Field of the Invention

The present invention relates to a computer program product, system, and method for determining play speeds for rendering video content in a video player.

### 2. Description of the Related Art

Viewers observing a video rendered in a computer video player delivered through a video streaming service may manually adjust the playback speed based on their comprehension or understanding of the content. Such manual controls in the video player allow the viewer to increase the speed when the content is easy to comprehend or decrease the speed if the content is difficult to comprehend. Video players often include a playback speed menu to select a video speed on a sliding scale or select one of a plurality of play speeds as a percentage of a “normal” play speed.

### SUMMARY

Provided are a computer program product, system, and method for determining play speeds for rendering video content in a video player. A determination is made of segment complexity scores of segments of a video are determined. A determination is made of user comprehension score for a viewer of the video with respect to a category of the video. A preferred speed predictor machine learning model receives input comprising the segment complexity scores and the user comprehension scores for the categories of the video to output predicted play speeds for the segments of the video. The segments of the video in the video player are rendered according to the predicted play speeds of the segments.

### BRIEF DESCRIPTION OF THE DRAWINGS

FIG. 1 illustrates a network computing environment to stream video from a media server to a client.

FIG. 2 illustrates an embodiment of a video speed control bot.

FIG. 3 illustrates an embodiment of video segments of a video.

FIG. 4 illustrates an embodiment of segment information in the video segments of FIG. 3.

FIG. 5 illustrates an embodiment of user comprehension scores for video content categories.

FIG. 6 illustrates an embodiment of a video speed information entry used to control the video play speed.

FIG. 7 illustrates an embodiment of monitored behavioral understanding scores.

FIG. 8 illustrates an embodiment of operations to generate segments for a video.

FIG. 9 illustrates an embodiment of operations to generate user comprehension scores for content categories.

FIGS. 10A and 10B illustrate an embodiment of operations to control the speed at which video content is rendered in a video player.

FIG. 11 illustrates an embodiment of operations to train a preferred speed predictor machine learning model to predict a preferred speed at which to render video for a viewer.

FIGS. 12A and 12B illustrate an example of video speed information entries.

FIG. 13 depicts a computing environment in which the components of FIGS. 1 and 2 may be implemented.

### DETAILED DESCRIPTION

Viewers of video content having different backgrounds, including different levels of education and work experience, may have different comprehension levels of video content, especially education content. For instance, current educational videos are typically static in nature, with a fixed video playing speed. This approach does not consider the varying comprehension levels and learning preferences of learners, leading to disengagement, frustration, and a lack of motivation to continue. Further, online education platforms serve a diverse audience, ranging from beginners to experts, each with distinct prior knowledge, learning paces, and preferences. A single video speed cannot accommodate this diversity effectively. Also, maintaining learner engagement throughout a video is a constant concern. Lengthy or complex videos often result in high dropout rates and reduced completion rates, undermining the effectiveness of online courses. Personalized learning experiences have proven to be more effective in knowledge retention. However, existing video content delivery methods lack the adaptability required to personalize the learning journey for each learner. Because of these issues of audiences of diverse backgrounds and skills, valuable educational content may not be fully utilized due to viewer difficulties in comprehending certain sections. This leads to suboptimal learning outcomes and underutilization of educational resources.

Described embodiments provide improved computer technology to determine optimal video playing speeds to render video content to a viewer based on a category and complexity of the video content and the viewer comprehension with respect to the category of the content. Described embodiments provide computer technology for intelligently and dynamically adjusting a video playing speed according to detected user comprehensive response, content complexity, user's interested points, and educator emphasized concepts. In response to a user request to start playing video content, a machine learning model may predict a user preferred video playing speed in each segment of the video according to current complexity level of the content, a category of the content, and the user comprehension score with respect to the content category.

During the rendering of a segment, behavioral program modules may monitor user behavioral responses to viewing the video, such as eye gazing points, facial expressions, head gestures, interaction with input devices to control the video, engagement metrics, etc. A user comprehension score may be calculated based on the different behavioral response metrics measured during video playback. The current video play speed for rendering the current segment may be adjusted based on the real-time user comprehension score of the segment being played to allow for a real-time adjusted optimal play speed tailored to the viewers comprehension of the rendered content.

Though this disclosure pertains to the collection of personal data (e.g., viewer data), it is noted that in embodiments, users opt into the system. In doing so, they are informed of what data is collected and how it will be used, that any collected personal data may be encrypted while being used, that the users can opt-out at any time, and that if they opt out, any personal data of the user is deleted.

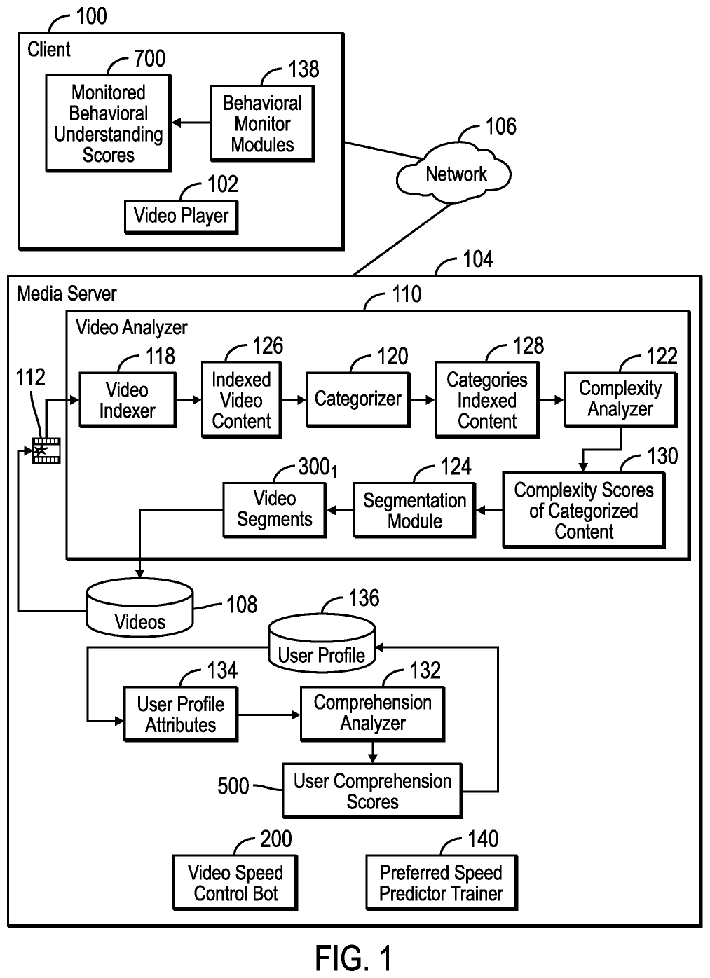

FIG. 1 illustrates an embodiment of a network computing environment having a client computer 100 that includes a video player 102 to play videos streamed from a media server 104 over a network 106. The media server 104 includes a video database 108 to stream to the clients 100. The media server 104 includes a video analyzer 110 to process a video 112 in a multimedia format in the video database 108 to generate metadata on the categories and complexity of segments of the video 112. The video analyzer 110 includes a video indexer 118, a categorizer 120, a complexity analyzer 122, and a segmentation model 124. The video indexer 118 produces indexed video content 126 according to the content. The categorizer 120, which may comprise a machine learning model classifier, processes the indexed video content 126 to classify the indexed video content 126 into categories indexed content 128, such as categories or domains of the indexed content, e.g., computer science, history, psychology, etc. The complexity analyzer 122, which may comprise a machine learning model, processes the categories 128 of the indexed content, including processing the categories 128 and the content, to determine a complexity score 130 of the indexed content of the category. The score 130 for each indexed content may comprise a value from 0 to 1, where a higher value indicates greater complexity. Alternatively, the score 130 may indicate a complexity classifier, such as beginner, intermediate, advanced, etc.

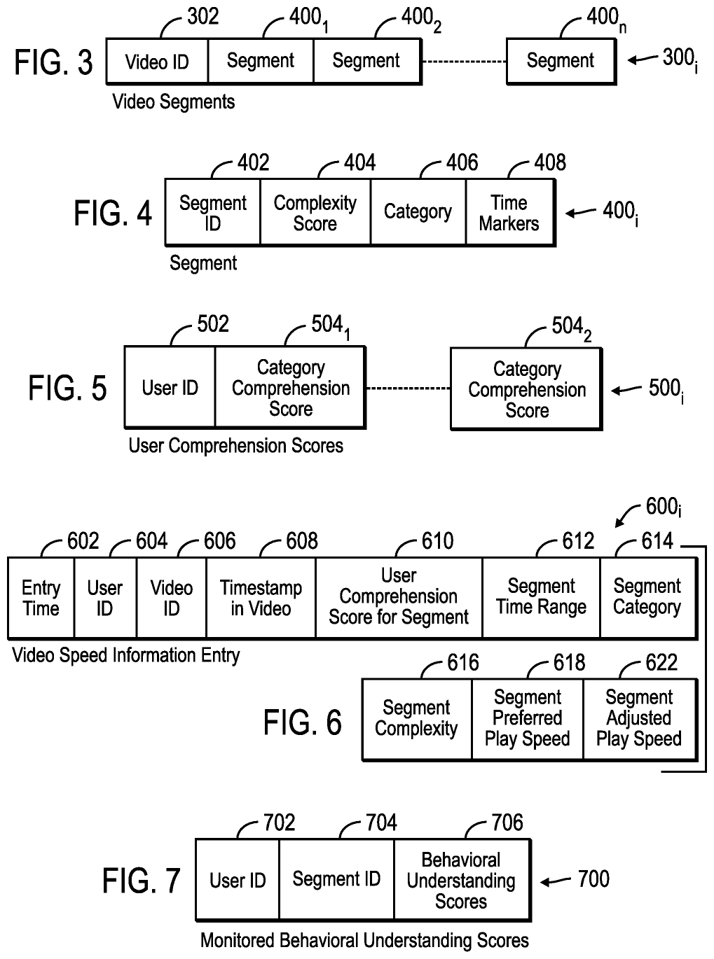

The segmentation module 124 processes the indexed content to generate video segments 300; of the video 112. A shown in FIG. 3, the video segments 300; for a video 112 include a video identifier 302 of the video 112 subject to the video analyzer 110 and the information on the determined segments 400₁ . . . 400ₙ. As shown in FIG. 4, the information for each segment 400; includes a segment ID 402, a complexity score 404 for the content in the segment 402 determined by the complexity analyzer 122, a category 406 for the content in the segment 402 determined by the categorizer 120, and time markers 408 indicating a timing in the video 302 where the segment 402 is located. The video segments 300; for a video may be stored in the video database 108.

The media server 104 includes a comprehension analyzer 132 to determine user comprehension scores 500 for users in the user profile database 136 with respect to categories and domains determined for the videos 112. The comprehension analyzer 132, which may comprise a machine learning model classifier, processes user profile attributes 134 from the user profile database 136, such as education level, educational degrees, work experience, project experience, etc., to output user comprehension scores 500; for the categories 128 outputted by the categorizer 120 for user i. As shown in FIG. 5, the user comprehension scores 500; for a user i may comprise a data structure including a user ID 502 of the user whose comprehension is considered and category comprehension scores 504₁ . . . 504ₙ indicating user comprehension determined by the comprehension analyzer 132 for each of the possible categories determined by the categorizer 120.

The media server 104 further includes a video speed control bot 200 to determine a speed at which to stream video 112 to the client video players 102 and a preferred speed predictor trainer 140 to train a preferred speed predictor 202 machine learning model, which predicts an initial speed at which to stream segments of a video for a user.

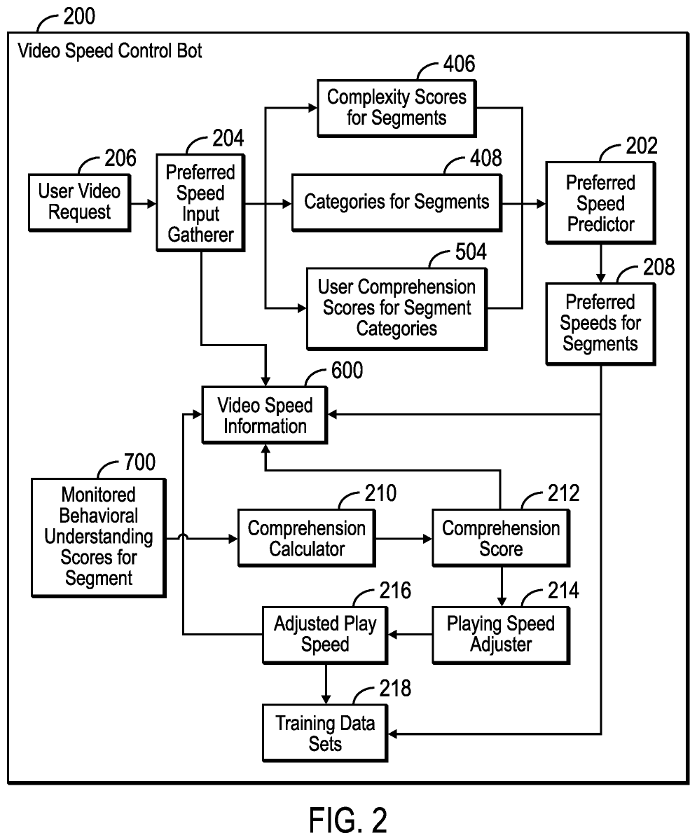

As shown in FIG. 2, the video speed control bot 200 includes a preferred speed input gatherer 204 that, in response to a user video request 206, from a client video player 102, gathers video complexity scores 404 for the segments 400₁ . . . 400ₙ for the requested video 302, categories 406 for the segments 400₁ . . . 400ₙ, and user category comprehension scores 504₁ . . . 504ₙ for the categories 406 of the segments 400₁ . . . 400ₙ in the requested video 206. The gathered information 406, 408, and 504 for all segments of the requested video 206 are inputted to the preferred speed predictor 202 to output preferred speeds for the segments 208. Different segments may have different speeds depending on the segment content complexity, categories, and user comprehension of the segment categories.

The gathered information 406, 408, 504 and the preferred speed 208 for a segment are added to an entry 600; in the video speed information 600. As shown in FIG. 6, an entry 600; in the video speed information 600 includes an entry time 602 the entry 600; was added; a user ID 604 of the viewer at the video player 102 requesting the video; a video ID 606 of the video being played; a timestamp 608 in the video 606 being streamed; a user comprehension score 610 for the segment being streamed, a segment time range 612 of the time markers of the segment being streamed in the video 606; a segment category 614; a segment complexity 616 of the segment; the segment preferred speed 618 comprising determined preferred speed 208 for the segment; and a segmented adjusted play speed 620, adjusted based on behavioral factors. The fields 610, 614, and 616 may comprise the gathered complexity score 404, the category 406, and the user comprehension score 504; gathered for the segment indicated in entry 600ᵢ, which is also inputted to the preferred speed predictor 202 to output the preferred speed 208 for the segment stored in field 618. In this way, the video speed data information 600 maintains information used to determine the play speed for a segment being streamed.

The video speed control bot 200 further receives monitored behavioral understanding scores 700 for a segment being rendered in the video player 102 from behavioral monitor modules 138 as in a client 100. The behavioral monitor modules 138 analyze information on viewer responses, interactions, and reactions to the segment being rendered in the video player 102 and generates scores 706 indicating extents to which the responses represent user real-time understanding of the content being rendered. As shown with respect to FIG. 7, the monitored behavioral understanding scores 700 include the user ID 702 of the viewer viewing the segment in the video player 102; a segment ID 704 of the segment being rendered in the video player 102 and a plurality of behavioral understanding scores 706 for different viewer behavior while viewing a segment in the video player 102. For instance, the behavioral monitor modules 138 may comprise machine learning models to produce understanding scores for the following responsive behaviors from viewers, including, but not limited to:
A machine learning model classifier to analyze, using computer vision, facial expressions captured from a video camera coupled to the client computer 100 to detect signs of engagement, confusion, interest, or frustration. The output may comprise a label of an emotion corresponding to the facial expression. Examples of monitored facial expressions include smiles, frowns, raised eyebrows, and attentive eye contact.
A machine learning model classifier to analyze, using computer vision or a motion monitor device worn by the user, head movements to identify when a user nods in agreement or shakes their head in disagreement or confusion. The output may comprise a label of an expression of agreement or disagreement corresponding to the head movement. For instance, consistent nodding may indicate comprehension, while frequent head-shaking may signal confusion.
A machine learning model classifier to track and analyze eye movement, using gaze track googles or glasses, to determine where the user is focusing attention within the video 112 rendered in the video player 102. The output may comprise a label of an extent to which the user comprehends the content based on the eye movements. For instance, rapid eye movements or frequent shifts in gaze may indicate difficulty following the content.
A machine learning model classifier to track and analyze viewer interaction with an input device, such as a mouse, cursor, keyboard, touchscreen, etc. The input to the machine learning model may comprise mouse or cursor movements on the screen to detect interactions with specific elements, such as pausing, rewinding, or clicking on subtitles. Frequent interaction with certain segments may suggest a need for clarification or review. Monitored input may further include keyboard inputs or touchscreen gestures to identify user-initiated actions, such as taking notes or highlighting text. These actions can provide insights into areas of interest or confusion.
A machine learning model classifier to analyze viewer speech and voice, using speech recognition to analyze the user's verbal responses, comments, or questions during video playback. Speech patterns and vocal cues can reveal the user's level of engagement and comprehension.
A machine learning model classifier to receive as input information on captured user interactions with video controls, such as play, pause, rewind, and fast forward. The timing and frequency of these interactions may indicate engagement and comprehension.
A machine learning model classifier to analyze engagement metrics like watch time, completion rate, and the number of rewinds or skips. Low watch time or frequent skips may indicate comprehension challenges.
A machine learning model classifier, using emotion recognition technology, to output indication of emotions such as happiness, frustration, or confusion in the user's voice or facial expressions.
A machine learning model classifier to analyze biometric data from biometric sensors such as heart rate monitors or EEG (electroencephalogram) devices to measure physiological responses related to comprehension and engagement, and output indication of comprehension or lack of comprehension.

A comprehension calculator 210 processes received monitored behavioral understanding scores 706 for a segment to determine a real-time comprehension score 212 of the rendered segment in the video player 102. The comprehension calculator 210 may weight the scores 706 and calculate the comprehension score 212 as a weighted aggregate of the scores 706 or comprise a machine learning model that can produce a comprehension score 212 from inputs comprising the monitored behavioral understanding scores 706. A playing speed adjuster 214 receives the comprehension score 212 and produces an adjusted play speed 216 depending on the level of user comprehension. The calculated comprehension score 212 and adjusted play speed 216 may be added to the video speed information entry 600; for the segment i. After calculating the adjusted play speed 216, the adjusted 216 and preferred speed 208 may be saved along with all inputs in training data sets 218 used to train the preferred speed predictor 202 machine learning model.

Generally, program modules, such as the program components 102, 110, 118, 120, 122, 124, 132, 136, 200, 202, 204, 210, 214, among others, may comprise routines, programs, objects, components, logic, data structures, and so on that perform particular tasks or implement particular abstract data types.

The programs 102, 110, 118, 120, 122, 124, 132, 136, 200, 202, 204, 210, 214, among others, may comprise program code loaded into memory and executed by a processor. Alternatively, some or all of the functions of these components may be implemented in hardware devices, such as in Application Specific Integrated Circuits (ASICs), Field Programmable Gate Arrays (FPGAs) or executed by separate dedicated processors.

The functions described as performed by the program components 102, 110, 118, 120, 122, 124, 132, 136, 200, 202, 204, 210, 214, among others, may be implemented as program code in fewer program modules than shown or implemented as program code throughout a greater number of program modules than shown.

The client computer 100 may comprise a personal computing device, such as a laptop, desktop computer, tablet, smartphone, wearable computer, mixed reality display, virtual reality display, augmented reality display, etc. The media server 104 may comprise one or more server class computing devices, or other suitable computing devices.

In described embodiments, the video analyzer 110, comprehension analyzer 132, and video speed control bot 200 may be maintained in a media server 104. In alternative embodiments, some are all of these components 110, 132, 200 may be maintained in the client 100 to perform these operations locally in the client for videos stored in the client 100.

In FIG. 1, arrows are shown between components in the client computer 100 and media server 104. These arrows represent information flow to and from the program components.

The network 106 may comprise a Storage Area Network (SAN), Local Area Network (LAN), Intranet, the Internet, Wide Area Network (WAN), peer-to-peer network, wireless network, arbitrated loop network, etc.

Certain of the program components, such as 118, 120, 122, 124, 132, 136, 202, 204, 210, 214, may use machine learning and deep learning algorithms, such as decision tree learning, association rule learning, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs. In backward propagation used to train a neural network machine learning module, biases at nodes in the hidden layer are adjusted accordingly to produce the output having specified confidence levels based on the input parameters. For instance, the input to the preferred speed predictor 202 may comprise information on complexity scores, categories, and user comprehension for segments, and the preferred speed predictor 202 may output preferred speeds for the segments 208. The machine learning models 118, 120, 122, 124, 132, 136, 202, 204, 210, 214 may be trained to produce their output for product information and product recommendations, respectively, based on the inputs. Backward propagation may comprise an algorithm for supervised learning of artificial neural networks using gradient descent. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In an alternative embodiment, the components 118, 120, 122, 124, 132, 136, 202, 204, 210, 214 may be implemented not as a machine learning model but implemented using a rules based system to determine the outputs from the inputs. The components 118, 120, 122, 124, 132, 136, 202, 204, 210, 214 may further be implemented using an unsupervised machine learning module, or machine learning implemented in methods other than neural networks, such as multivariable linear regression models.

Components implemented as a machine learning model may be implemented in programs in memory or in a hardware accelerator or an inference engine.

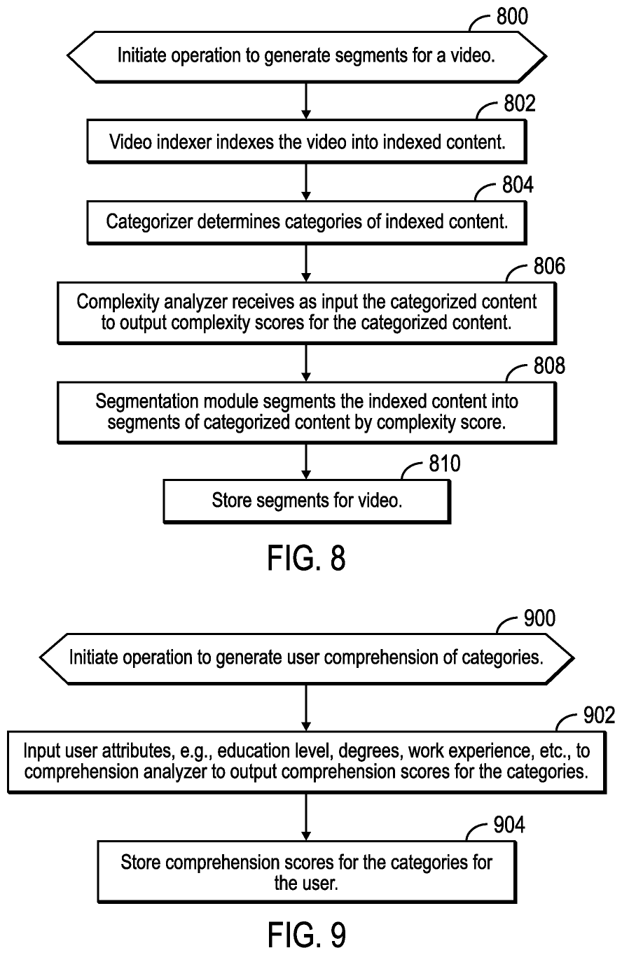

FIG. 8 illustrates an embodiment of operations performed by the video analyzer 110 to generate segments for a video 112. Upon receiving (at block 800) a video 112 to process, the video indexer 118 indexes (at block 802) the video 112 into indexed content 126. The categorizer 120 determines (at block 804) categories of the indexed content 128, e.g., computer science, entertainment genre, history, language, etc. The complexity analyzer 122 receives (at block 806) as input the categorized content 128 to output complexity scores for the categorized content 130. The segmentation module 124 segments (at block 808) the indexed content 128 into segments 400; of categorized content by complexity score 130. The segments 400; may comprise sequential indexed content in the video 112 having a same complexity score and category The segments 400; are stored (at block 810) in the video database 108 for later playback and streaming to clients 100.

With the embodiment of FIG. 8, content in a video 112 may be segmented into sequential streams of the video 112 having a same category and complexity score to allow different play speed settings to be set for a segment based on user comprehension of the segment as calculated by the comprehension analyzer 132.

FIG. 9 illustrates an embodiment of operations performed by the comprehension analyzer 132 to determine user comprehension scores 500; with respect to different content categories that may be classified by the categorizer 120. Upon initiating (at block 900) an operation to generate user comprehension scores 500; for different categories for later use in determining play speed settings, user attributes for a user from the user profile database 136, e.g., education level, degrees, work experience, etc., are inputted (at block 902) to the comprehension analyzer 132 to output user comprehension scores 500; for the possible categories outputted by the categorizer 120. These user comprehension scores 500; are saved (at block 904), such as in the user profile database 136, for later use in determining play speed settings with respect to segments of content of a specific category having a specific complexity.

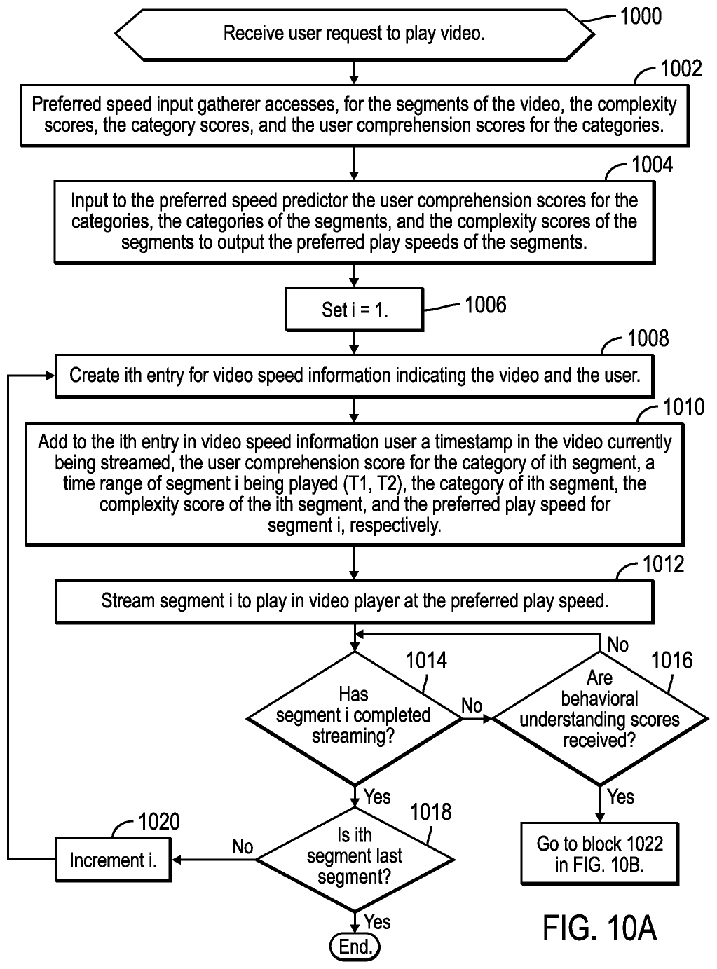

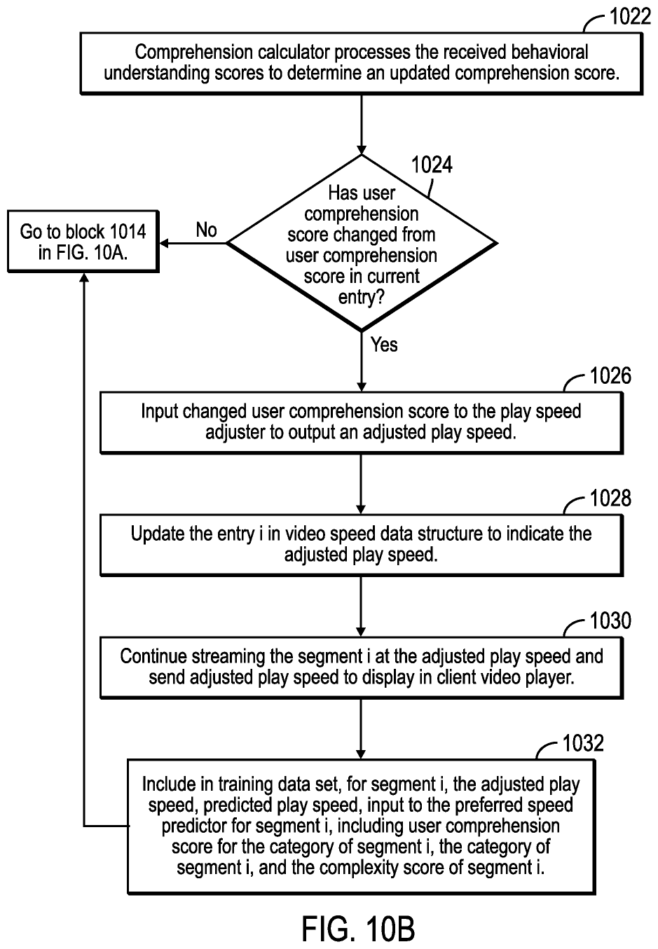

FIGS. 10A and 10B illustrate an embodiment of operations performed by the video speed control bot 200 to determine the play speed settings to use to stream video content to a client video player 102. Upon receiving (at block 1000) a request 206 to play a video 112, the preferred speed input gatherer 204 accesses (at block 1002), for the segments 400₁ . . . 400ₙ in the requested video 112, the complexity scores 404, the category 406, and the and the user comprehension scores for the categories 504ᵢ. The video speed control bot 200 inputs (at block 1004), to the preferred speed predictor 202, the user comprehension scores 500 for the categories, the categories of the segments, and the complexity scores of the segments to output the preferred play speeds 208 of the segments. A variable i is set (at block 1006) to 1. An ith entry 600; is created (at block 1008) in the video speed information 600 indicating the requested video 206 in field 606 and the user viewing the video in field 604 of the entry 600ᵢ. The video speed control bot 200 further adds (at block 1010), to fields 608, 610, 612, 614, 616 in the ith entry 600; in the video speed information 600, a timestamp in the video 608 currently being streamed, the user comprehension score 504ⱼ for the category 406 of ith segment 400ᵢ, a time range of segment i being played (T1, T2), the category 406 of ith segment, the complexity score 404 of the ith segment, and the preferred play speed 208 for segment i, respectively. The segment i is streamed (at block 1012) to the video player 102 over the network 106 at the preferred play speed 208.

If (at block 1014) the segment i has not completed streaming, i.e., is not at the end of the time range 612, and if (at block 1016) behavioral understanding scores 700 have been received from the client 100, then control proceeds to block 1022 in FIG. 10B. If (at block 1016) behavioral understanding scores are not received, control proceeds back to block 1014. If (at block 1014) the segment i has completed streaming and if (at block 1018) segment i is not the last segment, then i is incremented (at block 1020) and control proceeds back to block 1008 to stream the next segment 400ᵢ₊₁ of the video. If (at block 1018) segment i is the last segment in the video being streamed, then control ends.

Upon receiving behavioral understanding scores 706 (at block 1016), control proceeds to block 1022 in FIG. 10B where the comprehension calculator 210 processes the behavioral understanding scores 706 to determine an updated comprehension score 212. In certain embodiments, the comprehension calculator 210 may weight and aggregate the behavioral understanding scores 706 into the real-time user comprehension score 212.

For instance, in one embodiment, the behavioral understanding scores 706 may be derived from facial expressions (FE), engagement metrics (EM), eye-gazing (EG), and speech analysis (SA). The behavioral monitor modules 138 may output from the observed FE, EM, EG, and SA understanding scores 706 on a scale of 0 to 100, where 0 represents low comprehension or engagement, and 100 represents high comprehension or engagement. Weights may be assigned to each source based on their perceived importance. For example, if facial expressions are considered to be highly indicative of comprehension, engagement metrics moderately predictive, eye-gazing crucial, and speech analysis somewhat important, then the following weights may be applied: FE_weight=0.4, EM_weight=0.2, EG_weight=0.3, SA_weight=0.1. Further, thresholds and scoring rules for each type of behavioral metric, e.g., FE, EM, EG, SA. For instance, if a user displays a positive facial expression, it contributes positively to the score (e.g., +10). If engagement metrics indicate high engagement, it also contributes positively (e.g., +8). If eye-gazing behavior suggests active attention, it contributes positively (e.g., +12). If speech analysis indicates clear and coherent speech, it contributes positively (e.g., +6). The real-time comprehension score 212 is calculated for a specific time interval (e.g., per minute) using an equation, such as: (FE*FE_weight)+(EM*EM_weight)+(EG*EG_weight)+(SA*SA_weight).

If (at block 1024) the user comprehension score 212 has not changed from the current user comprehension score 610 in the video speed information 600; for the segment being rendered, then control proceeds back to block 1014 in FIG. 10A to continue rendering the video 112. If (at block 1024) the user comprehension score has changed, then the changed user comprehension score 212 is inputted (at block 1026) to the play speed adjuster 214 to output an adjusted play speed 216, and the user comprehension score 610 for the segment is updated to the real-time comprehension score. The entry 600; is updated (at block 1028) to indicate in field 610 the adjusted play speed 216. The segment i continues streaming (at block 1030) at the adjusted play speed 216 and the adjusted play speed 216 is sent to the client video player 102 to show the speed to allow the user to adjust. The video speed control bot 200 includes (at block 1032) in the training data set 218, for segment i, the adjusted play speed, predicted play speed, input to the preferred speed predictor for segment i, including user comprehension score for the category of segment i, the category of segment i, and the complexity score of segment i.

With the embodiment of FIGS. 10A and 10B, the play speed is optimized based on the complexity and category of the segment to play and the user comprehension for the category of the segment to determine an initial play speed to start playing the segment. Further, during real-time rendering of the segment in the video player 102, real time behavioral responses to the viewer observing the rendered segment may be gathered to quantize into a real-time user comprehension score of the current rendered segment. This real-time user comprehension score may then be used to determine whether to adjust the play speed, such as increase or decrease the video play speed, to better match the real-time user comprehension level of the segment. In this way, the play speed used to stream and render the video is optimized based on user current comprehension of what is being viewed.

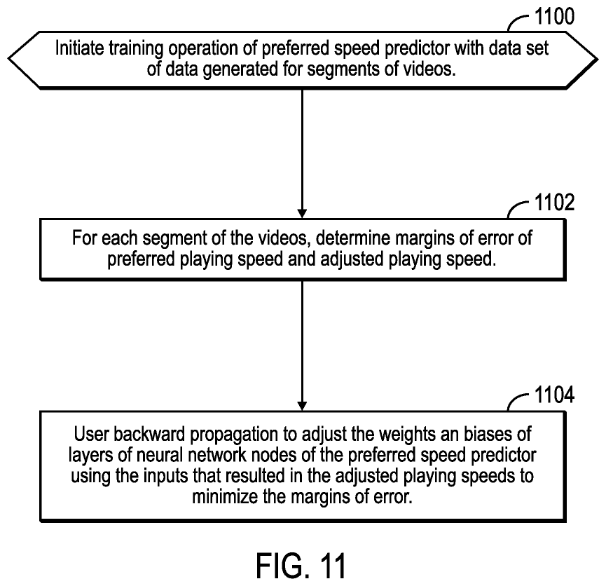

FIG. 11 illustrates an embodiment of operations performed by the preferred speed predictor trainer 140 to train the preferred speed predictor 202 with the training data sets 218 to minimize an error between the preferred speed and a subsequently determined adjusted play speed based on user responses to the segment being rendered. Upon initiating (at block 1100) a training operation, with data set 218 of training data generated for segments of videos, for each segment of the videos, the trainer 140 determines (at block 1102) margins of error of preferred playing speeds 208 and adjusted playing speeds 214. The trainer 140 then performs backward propagation (at block 1104) to adjust the weights and biases of layers of neural network nodes of the preferred speed predictor 202 using the inputs to output the adjusted playing speeds to minimize the margins of error. In this way, the preferred speed predictor 202 weights and biases are adjusted to output speeds closer to the adjusted play speed 216 that is based on user behavioral responses captured during playing of the segments of the video.

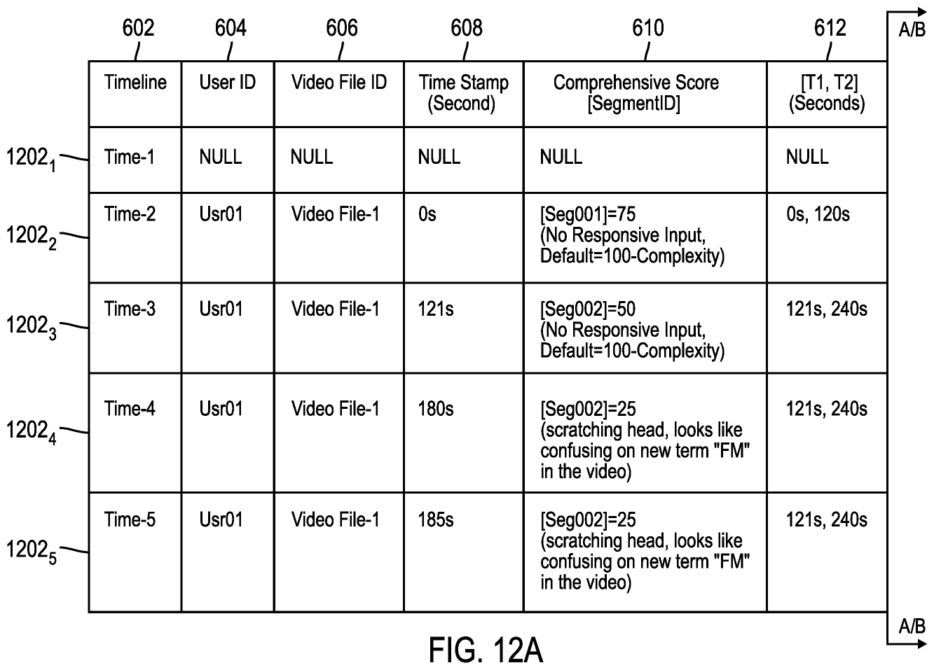

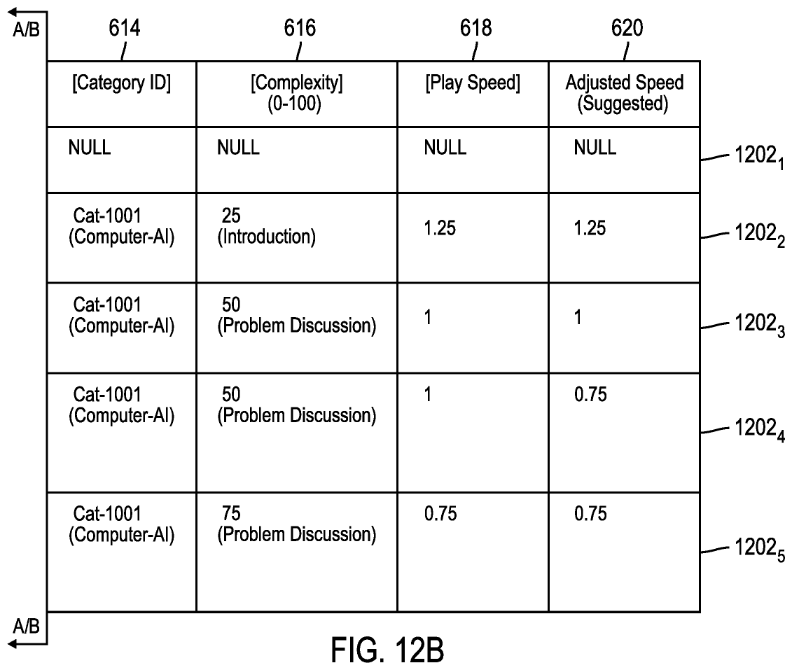

FIGS. 12A and 12B illustrate columns 1200A and 1200B of a table where each row 1202₁, 1202₂ . . . 1202₅ comprises an instance of play speed information 600; generated for a segment being played. The columns of the table 1200A, 1200B correspond to the fields of the video play speed information entry 600; shown in FIG. 6, and are labeled with the corresponding fields from the video play speed information entry 600ᵢ used in FIG. 6. For instance, in entry 1202₂ is created when getting ready to start Segment 001 with an initial suggested preferred play speed 618 of 1.25 times the normal speed. The adjusted play speed 620 is initially set to the preferred play speed 618. Then at time 3, in entry 1202₃, a new segment begins and has a user comprehension score 610 of 50 at the start. Then at time 4, in entry 1202₄, the user comprehension score 610 falls from 50 to 25, which results in the adjusted play speed 620 falling from 1 to 0.75 of normal speed. At time 5, in entry 1202₅, the user comprehension 610 remains the same at 25 and the play speed 618 is set to the adjusted play speed 620.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

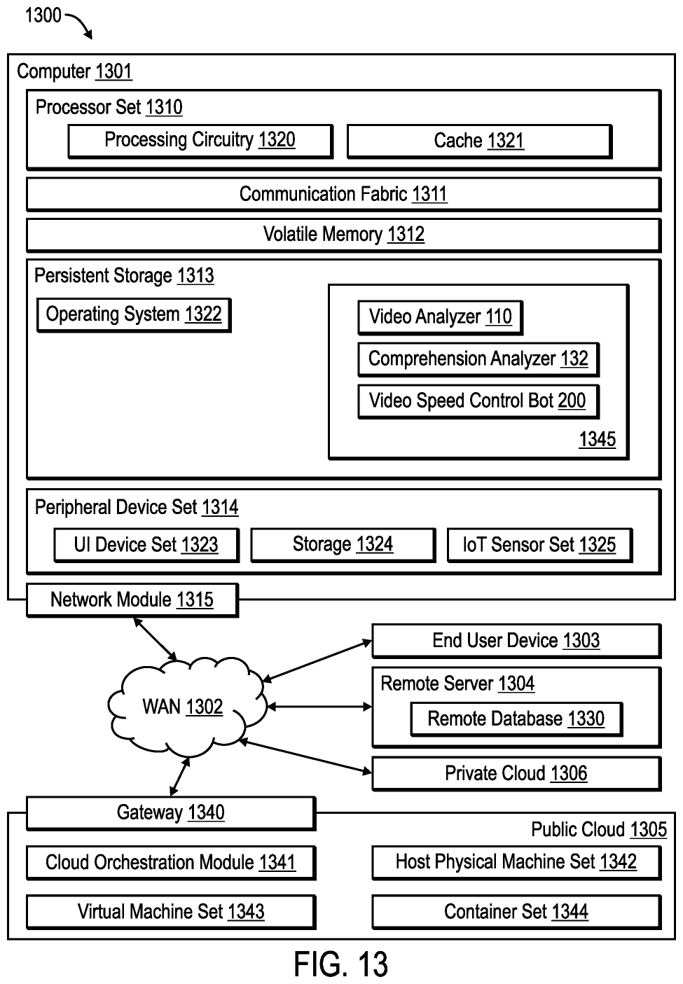

With respect to FIG. 13, computing environment 1300 contains an example of an environment for the execution of at least some of the computer code involved in performing the inventive methods, such as video play speed control components in block 1345 including the video analyzer 110, comprehension analyzer 132, and video speed control bot 200 described with respect to FIGS. 1 and 2. In addition to block 1345, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1345, as identified above), peripheral device set 1314 (including user interface (UI) device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1345 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, volatile memory 1312 is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface-type operating systems that employ a kernel. The code included in block 1345 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN 1302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on. The EUD 1303 may comprise the client 100 in FIG. 1, including components 136 and 102.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for controlling a play speed of video content in a video player, wherein the computer program product comprises a computer readable storage medium having computer readable program instructions that when executed perform operations, the operations comprising:
determining segment complexity scores of segments of a video;
determining a user comprehension score for a viewer of the video with respect to a category of the video;
receiving, by a preferred speed predictor machine learning model, input comprising the segment complexity scores and the user comprehension scores for the categories of the video to output predicted play speeds for the segments of the video; and
rendering the segments of the video in the video player according to the predicted play speeds of the segments.

2. The computer program product of claim 1, wherein the operations further comprise:
receiving a real-time comprehension score of viewer comprehension of the rendered segment based on computer program analysis of user behavioral responses to the rendered segment;
determining a play speed adjustment for the rendered segment based on the real-time comprehension score; and
adjusting a current play speed of the rendered segment according to the play speed adjustment to modify the play speed.

3. The computer program product of claim 2, wherein the play speed adjustment is a function of a maximum real-time comprehension score, a minimum real-time comprehension score, a minimum speed, and a maximum speed.

4. The computer program product of claim 2, wherein the user behavioral responses comprise a plurality of user behavioral responses in a set of user behavioral responses consisting of: facial expressions; head movements; eye movement; viewer interaction with an input device during playing of the video; voice analysis of viewer verbal responses and comments during the rendering of the video; viewer engagement with the played video; and biometric data gathered from the viewer, wherein the operations further comprise:
processing the user behavioral responses to determine user behavioral metrics; and
processing the user behavioral metrics to determine the real-time comprehension score of the viewer comprehension of the rendered segment.

5. The computer program product of claim 4, wherein the processing the behavioral metrics comprises:
applying weights to the behavioral metrics to produce weighted monitored behavior metrics, wherein the weights indicate strengths of the behavioral responses in predicting comprehension of the rendered segment; and
aggregating the weighted monitored behavior metrics to produce the real-time comprehension score of the viewer.

6. The computer program product of claim 1, wherein the determining the segment complexity scores comprises:
inputting the video to a complexity analyzer to determine complexity scores for content in the video; and
segmenting the video into segments, wherein each of the segments has content with one of the complexity scores.

7. The computer program product of claim 1, wherein the determining the segment complexity scores comprises:
indexing the video according to content;
inputting, to a categorizer machine learning model, the indexed video to categorize content of the indexed video;
inputting, to a comprehension analyzer machine learning model, the categorized content of the indexed video to output complexity scores for the categorized content; and
segmenting the video into segments for the categorized content.

8. The computer program product of claim 1, wherein the operations further comprise:
determining play speed adjustments to modify the predicted play speeds based on monitored viewer behavior;
forming a data set of the play speed adjustments for the predicted play speeds; and
using a margin of error of the play speed adjustments and the predicted play speeds to update weights and biases of the preferred speed predictor machine learning model to form a retrained preferred speed predictor that minimizes the margins of error.

9. A system for controlling a play speed of video content in a video player, comprising:
a processor; and
a computer readable storage medium having computer readable program instructions that when executed by the processor performs operations, the operations comprising:
determining segment complexity scores of segments of a video;
determining a user comprehension score for a viewer of the video with respect to a category of the video;
receiving, by a preferred speed predictor machine learning model, input comprising the segment complexity scores and the user comprehension scores for the categories of the video to output predicted play speeds for the segments of the video; and
rendering the segments of the video in the video player according to the predicted play speeds of the segments.

10. The system of claim 9, wherein the operations further comprise:
receiving a real-time comprehension score of viewer comprehension of the rendered segment based on computer program analysis of user behavioral responses to the rendered segment;
determining a play speed adjustment for the rendered segment based on the real-time comprehension score; and
adjusting a current play speed of the rendered segment according to the play speed adjustment to modify the play speed.

11. The system of claim 10, wherein the user behavioral responses comprise a plurality of user behavioral responses in a set of user behavioral responses consisting of: facial expressions; head movements; eye movement; viewer interaction with an input device during playing of the video; voice analysis of viewer verbal responses and comments during the rendering of the video; viewer engagement with the played video;
and biometric data gathered from the viewer, wherein the operations further comprise:
processing the user behavioral responses to determine user behavioral metrics; and
processing the user behavioral metrics to determine the real-time comprehension score of the viewer comprehension of the rendered segment.

12. The system of claim 9, wherein the determining the segment complexity scores comprises:
inputting the video to a complexity analyzer to determine complexity scores for content in the video; and
segmenting the video into segments, wherein each of the segments has content with one of the complexity scores.

13. The system of claim 9, wherein the determining the segment complexity scores comprises:
indexing the video according to content;
inputting, to a categorizer machine learning model, the indexed video to categorize content of the indexed video;
inputting, to a comprehension analyzer machine learning model, the categorized content of the indexed video to output complexity scores for the categorized content; and
segmenting the video into segments for the categorized content.

14. The system of claim 9, wherein the operations further comprise:
determining play speed adjustments to modify the predicted play speeds based on monitored viewer behavior;
forming a data set of the play speed adjustments for the predicted play speeds; and
using a margin of error of the play speed adjustments and the predicted play speeds to update weights and biases of the preferred speed predictor machine learning model to form a retrained preferred speed predictor that minimizes the margins of error.

15. A computer implemented method for controlling a play speed of video content in a video player, comprising:
determining segment complexity scores of segments of a video;
determining a user comprehension score for a viewer of the video with respect to a category of the video;
receiving, by a preferred speed predictor machine learning model, input comprising the segment complexity scores and the user comprehension scores for the categories of the video to output predicted play speeds for the segments of the video; and
rendering the segments of the video in the video player according to the predicted play speeds of the segments.

16. The computer implemented method of claim 15, further comprising:
receiving a real-time comprehension score of viewer comprehension of the rendered segment based on computer program analysis of user behavioral responses to the rendered segment;
determining a play speed adjustment for the rendered segment based on the real-time comprehension score; and
adjusting a current play speed of the rendered segment according to the play speed adjustment to modify the play speed.

17. The computer implemented method of claim 16, wherein the user behavioral responses comprise a plurality of user behavioral responses in a set of user behavioral responses consisting of: facial expressions; head movements; eye movement; viewer interaction with an input device during playing of the video; voice analysis of viewer verbal responses and comments during the rendering of the video; viewer engagement with the played video; and biometric data gathered from the viewer, further comprising:
processing the user behavioral responses to determine user behavioral metrics; and
processing the user behavioral metrics to determine the real-time comprehension score of the viewer comprehension of the rendered segment.

18. The computer implemented method of claim 15, wherein the determining the segment complexity scores comprises:
inputting the video to a complexity analyzer to determine complexity scores for content in the video; and
segmenting the video into segments, wherein each of the segments has content with one of the complexity scores.

19. The computer implemented method of claim 15, wherein the determining the segment complexity scores comprises:
indexing the video according to content;
inputting, to a categorizer machine learning model, the indexed video to categorize content of the indexed video;
inputting, to a comprehension analyzer machine learning model, the categorized content of the indexed video to output complexity scores for the categorized content; and
segmenting the video into segments for the categorized content.

20. The computer implemented method of claim 15, further comprising:
determining play speed adjustments to modify the predicted play speeds based on monitored viewer behavior;
forming a data set of the play speed adjustments for the predicted play speeds; and
using a margin of error of the play speed adjustments and the predicted play speeds to update weights and biases of the preferred speed predictor machine learning model to form a retrained preferred speed predictor that minimizes the margins of error.
